(19) United States
(12) Patent Application Publication
(10) Pub. No.: US 2003/0044559 A1
(43) Pub. Date: Mar. 6, 2003

(54) Articles for optical recording media and method for securing the same

(75) Inventors: Junkang J. Liu, Woodbury, MN (US); Bruce D. Kluge, Forest Lake, MN (US); Timothy J. O'Leary, White Bear Lake, MN (US)

Correspondence Address: Attention: George W. Jonas, Office of Intellectual Propery Counsel, 3M Innovative Properties Company, P.O. Box 33427, St. Paul, MN, 55133-3427, US

(73) Assignee: 3M Innovative Properties Company

(21) Appl. No.: 10/214,974

(22) Filed: Aug. 8, 2002

Related U.S. Application Data
(60) Provisional application No. 60/311,896, filed on Aug. 13, 2001.

(51) Int. Cl. B32B 9/00

(52) U.S. Cl. 428/40.1

(57) ABSTRACT

The invention is an article securable to an optical disc. A layer of repositionable adhesive is disposed on a backing wherein the repositionable adhesive has a higher adhesion level to the read/write surface of the optical disc than to that of a non-target surface. The backing is secured to an optical disc with the repositionable adhesive disposed against the read/write surface of an optical disc. To remove the article, the backing is peeled away from the optical disc. The layer of repositionable adhesive has a higher level of adherence to the backing than to the optical disc.

This Application claims priority from provisional U.S. Application 60/311896, filed Aug. 13, 2001 by Bruce Kluge, Jacob Liu, and Timothy O'Leary, which is incorporated by reference in its entirety herein.

### FIELD OF THE INVENTION

This invention describes the accessory articles used to pack, store, clean, protect, organize, and index optical recording media, such as, CD, VCD, DVD, and DVR. In particular, this invention relates to using adhesive coated articles to economically, efficiently, and safely pack, store, clean, protect, organize and index optical recording media during distribution, transportation, and use. More particular, this invention relates to using repositionable adhesives having selective adhesion to the reading side of optical discs.

### BACKGROUND OF INVENTION

Optical discs, including CD, LD, VCD, DVD, CD-R, CD-RW, and DVD-R, are thin circular plastic discs with various functional layers, generally constructed of polycarbonate. The proliferation of optical discs has become extensive. In addition, in recent years, recordable or writable compact discs have grown in popularity. Further, these discs have been used for archival data storage, immediate distribution of data and for many demonstration purposes.

Scratches caused by dirt or abrasion on the plastic surface of an optical disc can cause skipping, sound dropout, and data retrieval errors. Therefore, optical discs are traditionally sold and stored in jewel boxes (thick plastic storage boxes) to prevent scratches, dust, or even finger oils. However, jewel boxes are bulky and are not suitable for insertion in a book or catalog. Further, jewel boxes stored side-by-side, do not permit ready inspection, which makes it difficult to find a particular disc in the system.

To overcome above-mentioned challenges from jewel boxes, there are sleeve, pocket, or envelope type articles that are also used conventionally. The sleeves are typically made from two pieces of thin polymer or paper film with three sides sealed and one side open to allow insertion of the disc. The sleeves do not have any way to secure the discs in place. The disc movement in the pocket may still cause scratches on the discs. Additionally, the discs can slide out from the pockets and become lost or cause even more surface damage. To prevent sliding, the sleeves need to incorporate some method to secure discs, such as, by using caps on the sleeves, placing the sleeve such that the open end is up, or keeping the sleeve in another enclosed device, such as a closed box or a binder bag with zipper.

Disc protection films are known, such as the Cdfender® product made by Quest Marketing Group, Inc., Durant, Okla. In this product conventional pressure sensitive (tacky) adhesive is coated on the center of the film, such that the majority of the film is not attached to the disc, leaving room for contamination.

JP11321958, describes using a conventional acrylate pressure sensitive adhesive to store and to pack optical discs. Previous adhesives disclosed in the art for the CD protection sheets, are all pressure sensitive adhesives, that display aggressive tackiness to a wide variety of substrates, including skin and paper, after applying only light pressure. Those adhesives are also commonly called “tacky” adhesives that usually leave residues when removed from the attached surfaces.

Pressure sensitive adhesive sheets and articles have been used for attachment and/or storage of articles, such as mounting photographs in self-adhesive photo albums. Moreover, none of the prior storage articles and packaging articles for optical discs offers the ability to clean the discs.

There are variety of cleaning cloths, tissues, sprays, cleaning fluids and mechanical means on the market to remove particles from the surface of the discs by wiping on the surface. However, wiping on the plastic surface, in general, may cause scratches while cleaning the surface. Moreover, those cleaning articles may have cleaning functions but do not offer protection to the discs during storage. Using adhesive to clean a surface other than an optical disc is discussed in U.S. Pat. Nos. 6,014,788 and 5,027,465.

As society in general has brought “reduce, reuse, and recycle” into the mainstream, end users expect that package and storage articles be produced in an environmentally responsible manner. Therefore, creating packaging that takes less space, uses less resources, and is recycled (or at least realistically recyclable) not only meets consumer demand, but also provides cost benefits as well.

As discussed above, a need exists in the art for a new storage article and a new packaging article that takes less space than a jewel box, securely holds the disc in position to protect the disc from dirt and scratches and clean the surface of the disc.

### SUMMARY OF INVENTION

The invention is an article securable to an optical disc. A layer of repositionable adhesive is disposed on a backing wherein the repositionable adhesive has a higher adhesion level to the read/write surface of the optical disc than to that of a non-target surface.

The backing is secured to an optical disc with the repositionable adhesive disposed against the read/write surface of an optical disc. To remove the article, the backing is peeled away from the optical disc. The layer of repositionable adhesive has a higher level of adherence to the backing than to the optical disc.

### BRIEF DESCRIPTION OF THE DRAWINGS

In this disclosure several embodiments are illustrated. Throughout the drawings, like reference numerals are used to indicate common features or components of those devices.

FIG. 1 is a cross-sectional side view of an adhesive-coated sheeting.

FIG. 2 is a cross-sectional side view of an adhesive coated sheeting with an optional release liner covering adhesive an optional printed graphic on an optional ink receptive layer on the opposing major surface.

FIG. 3 is a cross-sectional side view of the adhesive coated sheeting having an optional primer layer between the adhesive coating and the back sheet.

FIG. 4 is a cross-sectional side view of the adhesive coated sheeting with a repositionable adhesive of the present invention on one major surface of the back sheeting and optional pressure sensitive adhesive on opposing major surface.

FIG. 5 is a cross-sectional side view of the adhesive coated sheeting with a repositionable adhesive of the present invention on one major surface of the back sheeting.

FIG. 6 is a perspective view of an adhesive coated sheet attached to the reading/writing side of an optical recording medium.

FIG. 7 is a perspective view of an adhesive coated sheet peeled back from the reading/writing side of an optical recording medium.

FIG. 8 is a perspective view of a printed adhesive coated sheet adhered to the reading/writing side of an optical recording medium.

FIG. 9 is a perspective view of a stack of adhesive coated sheets

FIG. 10 is a perspective view of a stack of adhesive coated sheets in a dispenser.

FIG. 11 is a perspective view of a roll of dispensable adhesive coated sheets.

FIG. 12 is a perspective view of adhesive coated sheets fabricated into three-ring-binder sheets and optical discs adhere on the surface of the adhesive coated sheets.

FIG. 13 is a perspective view of adhesive coated sheets attached in a book utilizing repositionable adhesive coated sheets with an optical disc secured on the surface of the repositionable adhesive.

FIG. 14 is a perspective view of a three-page-folder disc mailer with non-pressure sensitive adhesive laminated on the center section and an optical disc being secured on the surface of the repositionable adhesive.

FIG. 15 is a perspective view of a letter page with repositionable adhesive laminated on the letter page and an optical disc secured on the surface of the repositionable adhesive.

FIG. 16 is a perspective view of a disc rack with adhesive coated sheets and attached optical discs.

FIG. 17 is a perspective view of a rotary card file storage device with adhesive coated sheets and attached optical discs.

FIG. 18A is a close up photograph of an optical disc.

FIG. 18B is a close up photograph of an optical disc.

FIG. 19A is a close-up photograph of an optical disc.

FIG. 19B is a close-up photograph of an optical disc.

While the above-identified drawing figures set forth several preferred embodiments of the invention, other embodiments are also contemplated, as noted in the discussion. In all cases, this disclosure presents the invention by way of representation and not by limitation. It should be understood that numerous other modifications and embodiments can be devised by those skilled in the art which fall within the spirit and scope of the invention.

### DESCRIPTION OF THE PREFERRED EMBODIMENTS(S)

The invention relates to adhesive coated articles for securing reading sides of optical discs using repositionable adhesive which exhibits selective adhesions such that there is essentially no adhesion to paper but instant adhesion to targeted surfaces (such as polycarbonate of an optical recording media). Thus, such articles offer repositionability, which in turn permits easy reattachability of the article. All patents or publications cited within the current application are incorporated by reference in their entirety herein.

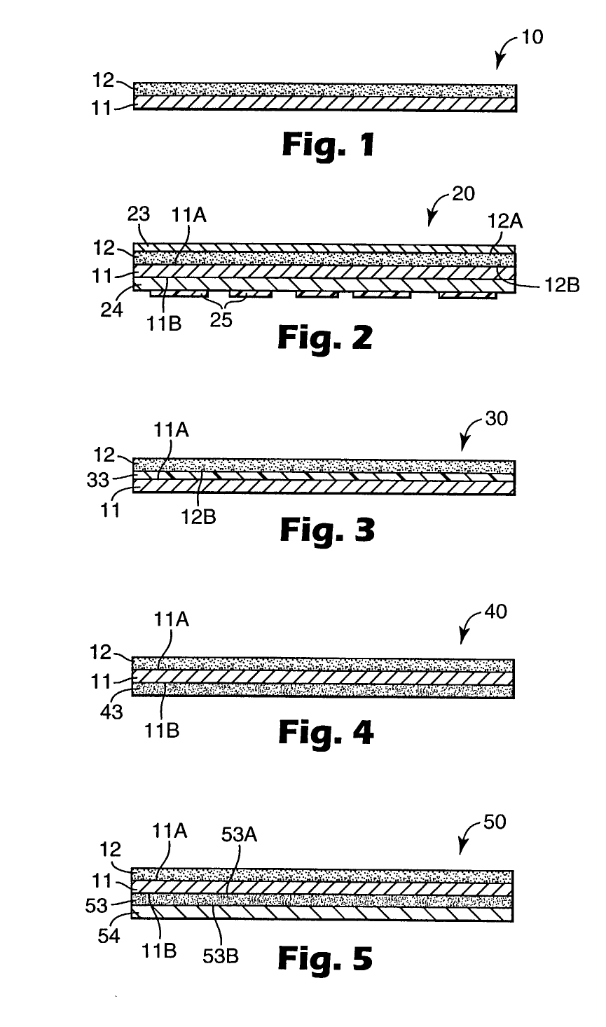

FIG. 1 shows a side view of one embodiment of the inventive repositionable adhesive sheet, generally indicated at 10. Repositionable adhesive sheet 10 is composed of backing 11 and layer of repositionable adhesive 12.

While backing 11 can be made from various materials having a wide range of thickness, preferably, backing 11 is flexible and is less than about 0.05 inches (about 1.3 mm) thick. More preferably, backing 11 is less than about 0.005 inches (about 0.13 mm) thick. Useful backings 11 for the application include papers, films, metallized papers, metallized films, foils, synthetic fabrics, non-wovens, and synthetic papers, for example Tyvek™ brand synthetic paper manufactured by E. I. du Pont de Nemours and Company, Wilmington, Del., among others. Useful examples for papers include uncoated paper, such as micro-fiber uncoated paper and paper with ink receptive coating on the opposite of the paper backing (coated paper), fiber board, cardstock and the like. Coated paper may be cast coated, gloss coated, and matte coated among others. Useful examples for films include polyvinyl chloride (vinyl film), polyester, polypropylene, polyethylene, polystyrene, acetate, and multilayer films among others. Backing choices may depend on a variety of factors and including a choice of printers. For example, polyolefin films such as polyethylene film and polypropylene film, may not be good choices for repositionable adhesive sheet 10 which will be printed on using toner and thermal wax type printers (not shown) because the hot drum in the printer may soften films. Like paper backing, film backing may also be coated with an ink receptive layer on the opposite side of the film. Laminates (e.g., using any of the materials identified above) may also be used for backing 11.

Preferably, repositionable adhesive 12 exhibits a low adhesion to skin or to paper but good adhesion to read and/or write surfaces of optical discs (or “targeted surfaces” or “read/write surfaces”). Repositionable adhesive 12 has a high “anchoring” (or affinity) adhesion to backing 11. Low adhesion to skin is generally referred to as “low tack”.

Suitable adhesives that could provide “selective adhesion” might be a homopolymer, a random copolymer, a graft copolymer, and a block copolymer. It may be crosslinked or uncrosslinked. Specific examples of the adhesives include thermoplastic block copolymer elastomer. Previous adhesives disclosed in the art for the CD protection sheets, are all pressure sensitive adhesives (PSA's) that display permanent and/or aggressive tackiness to a wide variety of substrates, including skin and paper, after applying only light pressure. Those adhesives are also commonly called “tacky” adhesives that usually leave residues when removed from the attached surfaces. Suitable adhesives in the current invention will adhere to read/write surfaces of optical discs while not adhering well to skin or paper.

Preferably, repositionable adhesive 12 exhibits an adhesion in the range of about 85 g/inch (about 3 oz/inch) to about 2550 g/inch (about 90 oz/inch) to targeted surfaces (in other words, the read and/or write surfaces (or read/write surfaces) of optical discs) and a low adhesion of less than about 230 g/inch (about 8 oz/inch) to non-target (or undesired) surfaces. More preferably repositionable adhesive 12 exhibits an adhesion of about 230 g/inch (about 8 oz/inch) to about 1100 g/inch (about 40 oz/inch) to targeted surfaces and less than about 28 g/inch (loz/in) to undesired surfaces. Even more preferably, the repositionable adhesive exhibits an adhesion of less than about 15 g/inch (0.5 oz/inch) to non-target surfaces. The read and/or write surface of an optical disc is the target surface on typically is a smooth surface and includes polycarbonate, polyester, glass, polyvinyl chloride or protective coating layers, such as polyacrylate and reflective coatings. Undesired (or “non-target) surfaces include skin, clothing and conventional printing paper and may include the material forming backing 11, to prevent separation problems if multiple inventive sheets 10 are stacked. Any of the above adhesives adhesive components that can be modified to selectively adhere, as described, are suitable for use in repositionable adhesive 12.

One commonly accepted quantitative description of a pressure sensitive adhesive is given by the Dahlquist criterion as described in the Handbook of Pressure Sensitive Adhesive Technology, 2^{nd} edition, Ed. By E. Satas, Van Nostrand Reinhold, New York, 1989. The Dahlquist criterion indicates that materials having a storage modulus (G′) of less than about 3×10⁵ Pascals (measured at 10 radians/second at room temperature, about 20° to 22° C.) have pressure sensitive adhesive properties. Materials which have a G′ in excess of this value do not. Thus, more specifically, a repositionable adhesive with selective adhesion, also called as “low-tack” adhesive, or sometimes “non-tacky” adhesive, as used herein, refers to an adhesive that has a storage modulus at least above the Dahlquist criterion line (i.e., greater than 3×10⁵ Pascals). Preferably, adhesive 12 of the current invention has a storage modulus (G′) above the Dahlquist criterion line. More preferably, adhesive 12 has a storage modulus above 1×10⁶ Pascals.

Many adhesives can be used for repositionable adhesive 12 of the current invention. For example, polyisoprenes-elastomers, ethylene-containing copolymers, urethane polymers, acrylic and acrylate polymers, urethane-acrylate copolymers, butyl rubber, butadiene-acrylonitrile polymers, butadiene-acrylonitrile-isoprene polymers, silicone elastomers, silicone urea block copolymer elastomers, and conventional thermoplastic block copolymer elastomers (discussed further below) may all be utilized. Blends and mixtures of polymeric materials may be used if desired. Further discussion regarding adhesives may be found in a number of publications. For example, EP0443263 discloses a general tape construction with a low tack or non-tacky adhesive; U.S. Pat. No. 5,851,664 discloses a semiconductor wafer processing tape with a low tack or a non-tacky adhesive; U.S. Pat. Nos. 5,888,335, 5,908,695, and 6,004,670 each discloses a releasable fastener with a low tack or non-tacky adhesive; and U.S. Pat. No. 6,099,682 discloses a package sealing tape with a low tack or non-tacky adhesive. U.S. patent application Ser. No. 09/849147, filed May 4, 2001 by Jacob Liu, Timothy O'Leary, Ned Johnson and Bruce Kluge also includes discussions relevant to the current application. As previously stated, all references (including all patent applications, published patents, and printed publications) listed throughout the current application are incorporated by reference in their entirety herein.

Thermoplastic block copolymer elastomer refers to a copolymer of segmented A and B blocks or segments and which displays both thermoplastic and elastomeric behavior. Thermoplastic block copolymer elastomers useful as the repositionable adhesive invention include multi-block copolymers having radial, linear A-B diblock, and linear A-B-A triblock structures, as well as blends of these materials. A wide variety of commercially available thermoplastic block copolymer elastomers may be used (either alone or in combination) in the invention including the SOLPRENE family of materials (from Philips Petroleum Co., Bartlesville, Okla.), the FINAPRENE family of materials (from ATOFINA, Philadelphia, Pa.), the TUFPRENE and ASAPRENE family of materials (from Asahi Kasei, Tokyo, Japan), the STEREON family of materials (from Firestone Polymers, Akron, Ohio), the EUROPRENE SOL T family materials (EniChem Elastomers Ltd., Hampshire, England), the VECTOR family of materials (Dexco Polymers, Plaquemine, La.), and the CARIFLEX TR family of materials (Shell Chemical Co., Houston, Tex.). Also useful is silicone polyurea elastomer (U.S. Pat. No. 5,670,598), the SEPTON family of materials (Kuraray Co. Ltd., Osaka, Japan) and the KRATON family of materials (Kraton Polymers, Houston, Tex.), such as D-1101, D-1102, D-1107, D-1111, D-1112, D-1113, D-1114PX, D-1116, D-1117, D-1118, D-1119, D-1122X, D-1124, D-1125PX, D-1160, D-1165, D-1161, D-1184, D-1193, D-1300, D-1320X, D-4141, D-4158, D-4433, RP-6485, RP-6409, RP-6614, RP-6906, RP-6912, G-1650, G-1651, G-1652, G-1654, G-1657, G-1701, G-1702, G-1726, G-1730, G-1750, G-1765, G-1780, FG-1901, FG-1921, FG-1924, and TKG-101. Mixtures of any of the above thermoplastic block copolymer elastomers are also permissible. In general, KRATON elastomers are preferred.

Various other materials may be incorporated into the adhesive materials forming repositionable adhesive 12. For example, tackifiers oil or liquid rubber may be used to modify the adhesion level, quick stick level, and/or viscosity of adhesive coating solutions. Additionally, fillers, pigment, plasticizers, antioxidants, UV stabilizers, photo crosslinkers, and so forth may be also employed.

Tackifiers useful in the repositionable non-pressure sensitive adhesive 12 are typically low molecular weight materials and are usually compatible with the thermoplastic block copolymer elastomer, by which it is meant that there is no visible evidence of phase separation of these components at room temperature. Examples of commercially available tackifiers include Wingtack95 and Wingtack115 (from Goodyear Tire and Rubber Co., Akron, Ohio); Regarlrez1078, Regalrez1094, and Regalrez1126 (from Hercules Chemical Co. Inc., Wilmington, Del.); Akron P115 (from Arakawa Forest Chemical Industries, Chicago, Ill.); Escorez (from Exxon Chemical Co., Houston, Tex.); and Foral 85 and Foral 105 (from Hercules Chemical Co., Inc.,Wilmington, Del.).

Photo crosslinkers suitable for repositionable adhesive 12 include aldehydes, such as benzaldehyde, acetaldehyde, and their substituted derivatives; ketones such as acetophenone, benzophenone and substituted derivatives such as Sandoray 1000 (Sandoz Chemicals, Inc.); quinones such as the benzoquinones, anthraquinone and their substituted derivatives; thioxanthones such as 2-isopropylthioxanthone and 2-dodecylthioxanthone; and certain chromophore substituted halomethyl-sym-triazines such as 2,4-bis-(trichloromethyl)-6-(3′,4′-dimethoxyphenyl)-sym-triazine.

FIG. 2 shows a side view of an alternate embodiment of repositionable adhesive sheet 20 with additional layers. A release liner 23 is disposed on a first side 12A of adhesive layer 12. Second side 12B of adhesive layer 12 is disposed on first side of backing 11. An ink receptive layer is disposed second side 11B of the backing 11.

The sheet construction shown in FIG. 2 can be inserted into an inkjet printer or a laser jet printer (not shown). Alphanumerics and graphics, generally indicated by reference number 26, can be printed onto the ink receptive layer 24. The printer mechanism is protected from adhesive layer 12 by the release liner 23. Once sheet 20 is printed, release liner 23 can be discarded. Advantageously, release liner 23 could be a standard silicone-type release liner, but it could also be a piece of paper, such as standard copier or printer paper. If release liner 23 is standard paper, once the sheet is printed, the paper can be “recycled” and used in the printer for regular printing, or can be discarded into a recycle bin, without environmental concerns generally associated with silicone-type release liners. Useful examples of release liner 23 may also include polyolefin coated papers, such as polyethylene coated paper and films, such as PE and PP films.

Ink receptive layer 24 is typically a water-absorbing layer that has a blend of crosslinked, water absorbing polymer particles, a water insoluble binder polymer, and optionally, inert organic or inorganic particles that impart a matte finish on at least one major surface of the substrate. The preferred water-absorbing particle is crosslinked polyvinyl pyrollidone. The preferred water insoluble binder polymer comprises acrylate and acrylate/styrene copolymers containing ammonia neutralized acrylic acid or methacrylic acid groups. The inert particles can be silica or other inorganic particle or can also be organic pigments imparting a color to the coating. Useful examples of ink reception layer formulations may include Imprintable Overprint Varnishes (conmmercially available from Sun Chemicals, Fort Lee, N.J.) as OVP-NLJGW0830337 and OVP-RCIFV0482192).

FIG. 3 illustrates an alternate embodiment of repositionable adhesive sheet 30, wherein secondary layer 33 is disposed between first side 11A of backing layer 11 and second side 12B of adhesive layer 12. The secondary layer 33 could be a primer layer, a barrier layer, or any kind of layer that would be typically used by someone skilled in the art of making adhesive coated articles. The secondary layer 33 can be a barrier, a primer, or a coating that adds rigidity to the backing to facilitate the elimination of air bubbles that would prevent cleaning on some areas of the disc during application of the invention. In one embodiment, layer 33 is an ink layer which can form indicia or designed graphics. In this case, ink layer 33 would be protected by backing 11 and adhesive 12.

In one example, using primer as secondary layer 33 between backing 11 and repositionable adhesive 12 can enhance adhesive 12 anchorage onto backing 11. Although chemical priming (e.g., as secondary layer 33) may be used in the invention, physical priming on the backing, especially for film backing or film coated paper backing, including Corona, flame, ozone, and plasma treatment, is generally preferred. Such processes for physical priming are generally known to those skilled in the art, and enhance anchorage of adhesive 12 onto backing 11.

In another example, barrier coating as secondary layer 33 may also be needed, especially when a paper backing is used. Typical barrier coatings are thin polymer coatings, including polyethylene, polypropylene, and PET. It is found that a barrier coating makes a rough backing smoother, which in turn enhances adhesion of the adhesive on desired surfaces. Further, repositionable adhesive 12 itself may be microstructured to modify peel adhesion. For example, the repositionable adhesive 12 can be pattern-coated onto backing 11 or repositionable adhesive 12 can be coated onto liner 23 (see FIG. 2), which is microstructured.

FIG. 4 illustrates an alternate embodiment of repositionable adhesive sheet 40. Repositionable adhesive 12 is disposed (e.g., by coating) on first side (or surface) 11A of backing 11. Conventional pressure sensitive adhesive 43 is coated on second side (or surface) 11B of backing 11. Conventional pressure sensitive adhesives (PSAs) are generally known to those skilled in the art and selected from the classes of acrylate PSAs, natural rubber PSAs, synthetic rubber (blocked copolymers) PSAs, silicone PSAs, polyolefin PSAs or the blends of the above.

FIG. 5 illustrates an alternate embodiment of repositionable adhesive sheet 50 wherein (non-pressure sensitive) repositionable adhesive 12 is coated on first side 11A of backing 11 and first side 53A of conventional pressure sensitive adhesive (PSA) 53 is disposed (e.g., by coating) on second side 11B of backing 11. Silicone release liner 54 is disposed on second side 53B of PSA 53. Silicone release liners are generally known to those skilled in the art.

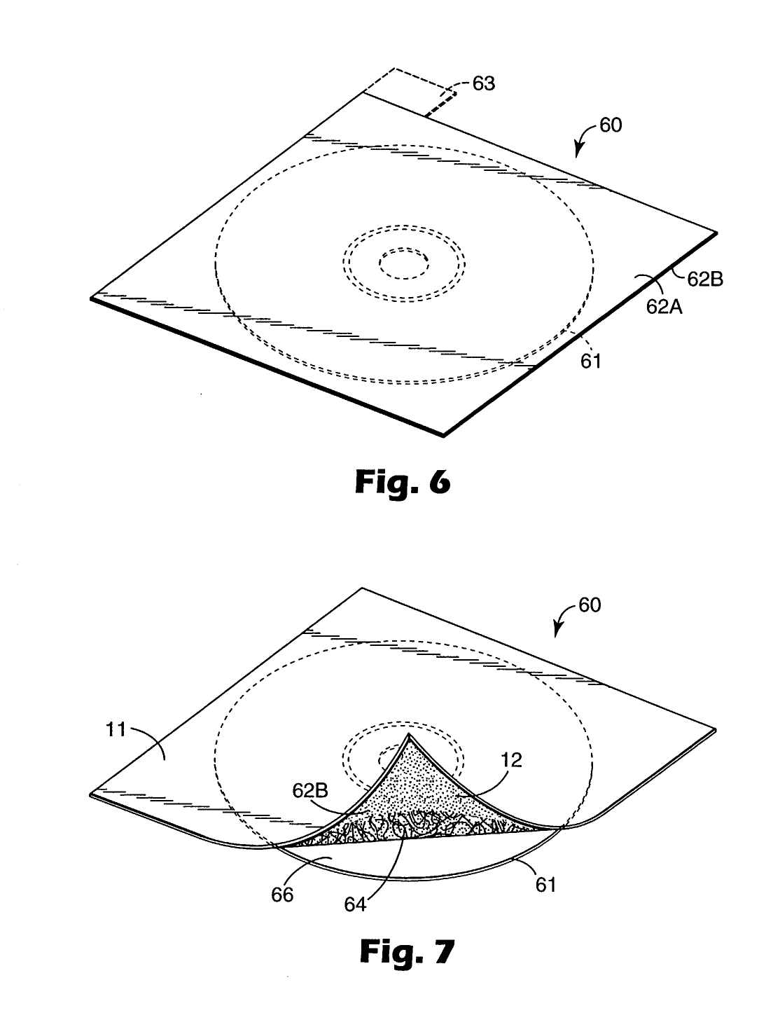

FIG.'S 6-17, illustrate various exemplary article configurations of the inventive repositionable adhesive sheet and optical disc. The repositionable adhesive sheet is attached to the reading (and/or writing) side of an optical recording medium which (which may be referred to as read/write surface) and it can be used as a disc-cleaning article that once the adhesive coated sheet is removed, it will also remove dust and fingerprints. While FIGS. 6-17 illustrate exemplary embodiments of the present invention, in no way should these embodiments limit the scope of the present invention.

FIG. 6 illustrates repositionable adhesive sheet 60 of the present invention disposed on optical disc 61 (shown in dotted lines). Sheet 60 is illustrated having first and second major surfaces 62A and 62B that have a generally square shape. It should be noted that sheet 60 can have any convenient shape, including round, triangular, hexagonal, and irregular shapes (among many others) according to the end application (e.g., whether the match of the shapes between disc 61 and sheet 60 is necessary). First major surface 62B is disposed against optical disc 61, providing protection from scratches on optical disc. Sheet 60 can further have tab(s) that can be used for indexing purposes or for handling purposes. One exemplary tab is shown in dotted lines as reference number 63.

FIG. 7 illustrates one corner of sheet 60 “peeled back” from optical disc 61 such that second major surface 62B having repositionable adhesive 12 is exposed. As would be understood by someone skilled in the art, instead of removing sheet 60 from optical disc 61, optical disc 61 can be removed from sheet 60 according to the rigidity of sheet 60, and the end use application. As can be seen, repositionable adhesive 12 is placed against read (and/or read/write) surface 66 of optical disc 61. Thus, read/write surface 66 is protected by repositionable adhesive sheet 60 from scratches that can occur during storage or transfer of optical disc 61. When it is desirable to use optical disc 61 (e.g. in a compact disc player), respositionable adhesive sheet 60 is “peeled back” from optical disc 61, exposing read/write surface 66. Repositionable adhesive 12 has higher adhesion to backing 11 than to optical disc 61 and remains with backing 11, preventing adhesive residue from remaining on optical disc 61 and affecting performance of disc 61. This is due to the use of “low tack” adhesive described previously.

Additionally, particulate 64 (such as dirt, oils, etc.) is shown being removed from read/write surface 66 of optical disc 61. Dirt and particulate 64 is removed due to the higher adhesion level of dirt and particulate 64 to repositionable adhesive 12 than the adhesion of dirt and particulate 64 to read/write surface 66. Unlike wiping a disc with a tissue, using adhesive sheet 60 to clean disc 61 will not cause particulate 64 to slide on disc 61, substantially reducing the potential of scratching disc 61 during cleaning. Moreover, because of the nature of repositionable adhesive 12, while particulate 64 is transferred to repositionable sheet 60, substantially no residue of adhesive 12 is transferred onto read/write surface 66 of optical disc 61. Thus, sheet 60 acts to both protect read/write surface 66 as well as clean read/write surface 66. Very little (if any) residue of adhesive is transferred because such “low tack” adhesive is made from living polymerization so that low molecular weight fraction is very small, if there is any at all, and also because a small percentage of low molecular weight additives are used in the invention.

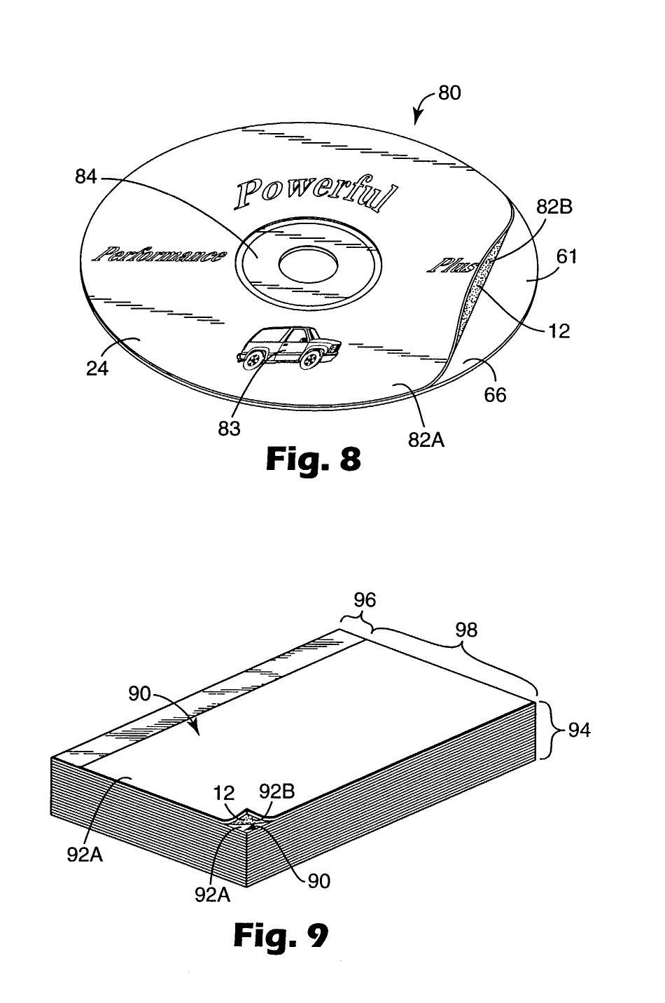

FIG. 8 illustrates one embodiment of repositionable adhesive sheet 80 releasably secured to read/write surface 66 of optical disc 61. Sheet 80 includes first and second major surfaces 82A and 82B. First major surface 82A includes indicia 83 that may be printed using a variety of methods including using ink-jet printers that the end user (consumer) can create and print, or alternatively which is pre-printed on sheet 80 before sale. Sheet 80 includes repositionable adhesive 12 and may include ink receptive layer 24 as described previously with respect to FIG. 2. Note that sheet 80 has “doughnut” shaped first and second major surfaces 82A and 82B that allows access to center mounting portion 84 of optical disc 61. The indicia can be selected for disc identification purposes (e.g., matching the contents of the digital information of the disc) or for product promotion, such as an advertisement.

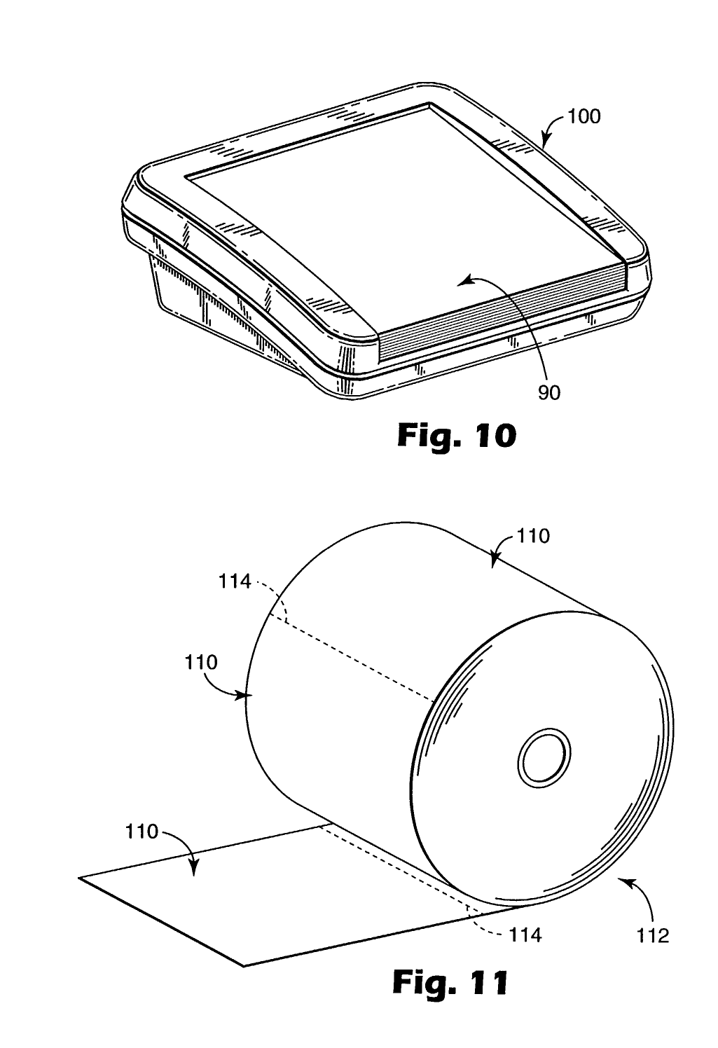

FIG.'S 9-11 illustrates dispensing articles for inventive repositionable adhesive sheet. As described, with respect to FIG. 6, FIG.'S 9-11 can have almost any shape. FIG. 9 illustrates one embodiment of inventive repositionable adhesive sheets 90 disposed such second major surface 92B of one sheet 90 is disposed on top of first major surface 92A of an adjacent sheet 90, forming stack 94 of sheets 90. Sheets 90 may be secured in stack 94 configuration using various methods known in the art such as by using adhesive on a first portion 96 of each sheet 90 which secures each sheet 90 to the sheet(s) immediately adjacent and providing perforations to allow separation of the remaining portion 98 of each sheet 90 from first portion 96. Alternatively, repositionable adhesive 24 may secure each sheet 90 to the immediately adjacent sheet 90. FIG. 10 illustrates stack 90 disposed in an exemplary dispenser 100.

In an alternate embodiment, repositionable adhesive sheets 110 can be formed in a roll 112, as illustrated in FIG. 11. Perforations 114 may be utilized to separate adjacent sheets 110. Further embodiments utilizing the inventive repositionable sheets in organizational devices are illustrated in FIG.'S 12-17.

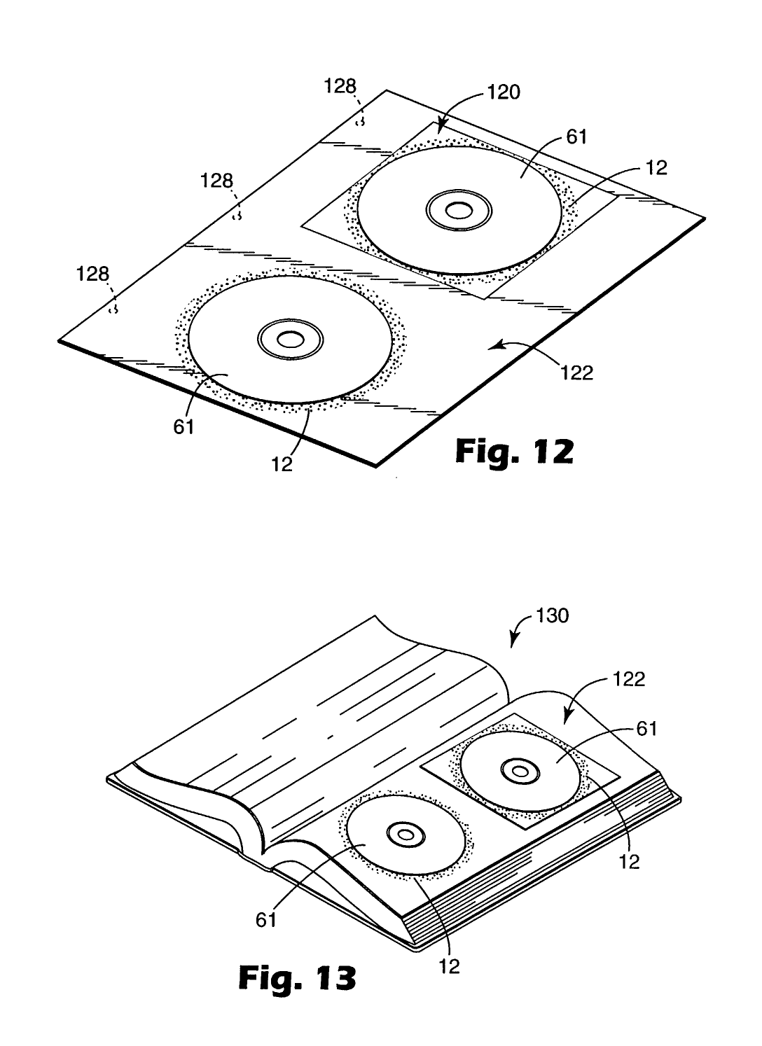

FIG. 12 illustrates repositionable adhesive sheet 120 secured to sheet 122. Sheet 122 can be separate from repositionable adhesive sheet 120 such that repositionable adhesive sheet 120 is secured to sheet 122 (e.g., using PSA or other securing method) and optical disc 61 is secured to repositionable adhesive 12. Sheet 120 can be bigger, equal, or smaller that disc 61 and can have the same or different overall shape than disc 61. Alternatively, repositionable adhesive 12 may be disposed directly on sheet 122 allowing optical disc 61 to be placed directly on sheet 122. Holes 128 (shown in dotted lines) can be disposed through sheet 122, allowing sheet 122 to be secured in a ring-type binder (not shown) known in the art. Alternately, sheet 122 may be bound into book 130 as illustrated in FIG. 13.

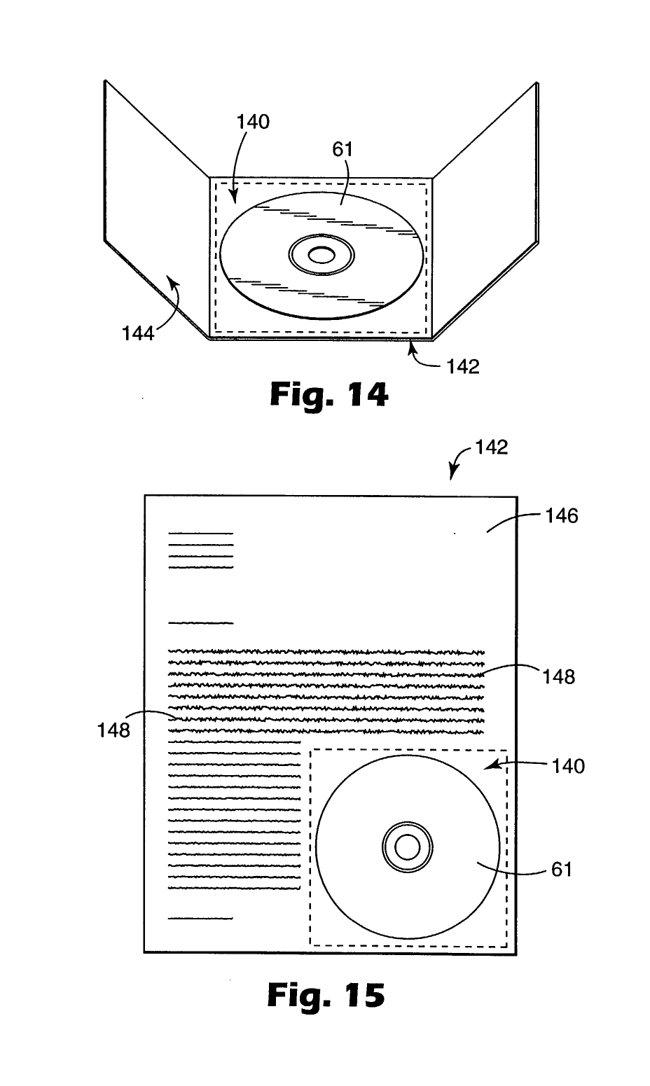

Similarly as indicated in FIG. 14, repositionable adhesive sheet 140 may be attached (indicated by dotted lines) to or formed integrally as part of advertising mailer 142. Again, sheet 140 can be bigger, equal to or smaller than disc 61 and can have a different overall shape than disc 61. Mailer 142 can be a tri-fold brochure 144, as illustrated in FIG. 14, or may be in the form of a single sheet, 146 as illustrated in FIG. 15. Indicia 148 may be printed on advertising mailer 142.

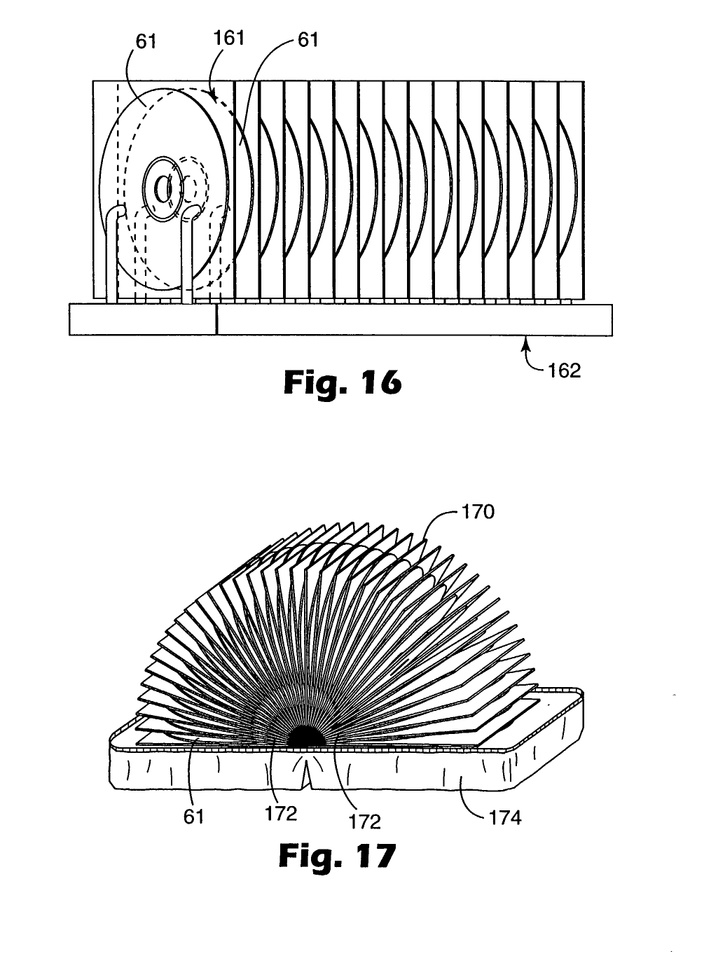

Alternate storage methods for optical discs 61 are illustrated in FIG.'S 16 and 17. As shown in FIG. 16, optical discs 61 are secured to repositionable adhesive sheets 161 which are then stacked in rack 162. Configuration of rack 162 is exemplary. A person skilled in the art would realize that other rack configurations could be used in conjunction with repositionable adhesive sheet 161. Similarly, repositionable adhesive sheets 170 can be utilized with a “fan” type retaining system 170, as illustrated in FIG. 17. Optical discs 61 are disposed on repositionable adhesive sheets 170 which are attached at a common end 172, allowing adhesive sheets 170 to be “fanned” for viewing, or collapsed for storage. An outer case 174 may be provided which can enclose repositionable adhesive sheets 170 in the “collapsed” position.

Further embodiments of the invention are found in the following examples, but not limited by the examples.

### EXAMPLES 1-3

A series of disc cleaning sheets according to the invention were prepared. The adhesive composition used in the example 3 was prepared by mixing 40 grams of thermoplastic block copolymer elastomer (Kraton G1657 commercially available from Kraton Polymers, Houston, Tex.) and 100 grams of toluene in a glass jar on a roller mill until no undissolved thermoplastic block copolymer elastomer was visible. Total mixing time was longer than 12 hours. The adhesive composition solution was then coated onto matte side of a Glossy Digital Paper (commercially available from Japan Pulp & Paper (USA) Corporation, Stone Mountain, Ga.) using a knife coater configured with a coating gap that insured a dry adhesive coating thickness of about 75 μm. Once coated, the sheets were dried for about 15 minutes at 70° C. The adhesive coated sheets were further die cut into CD shapes with a tab

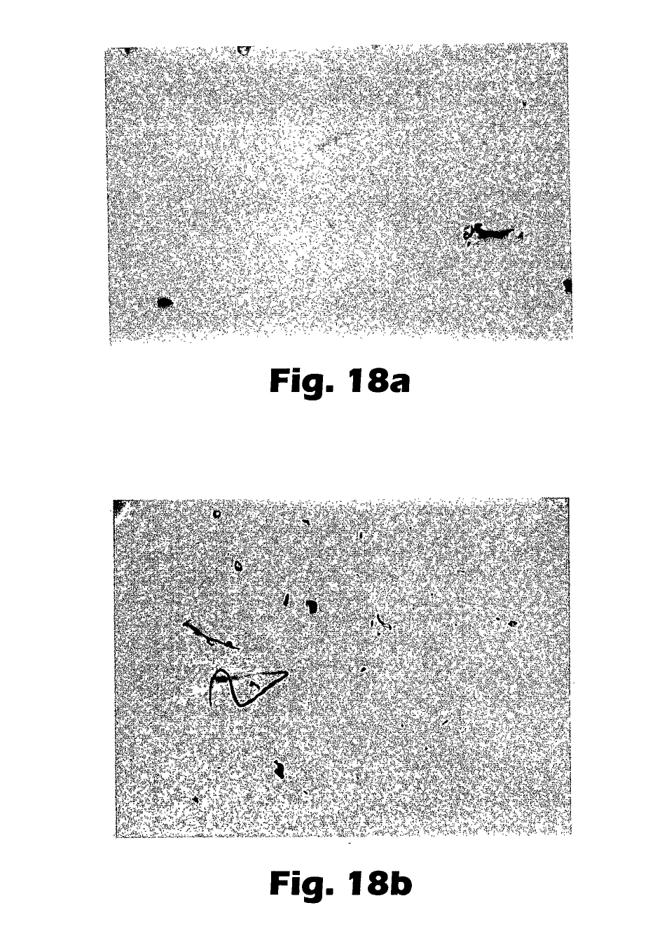

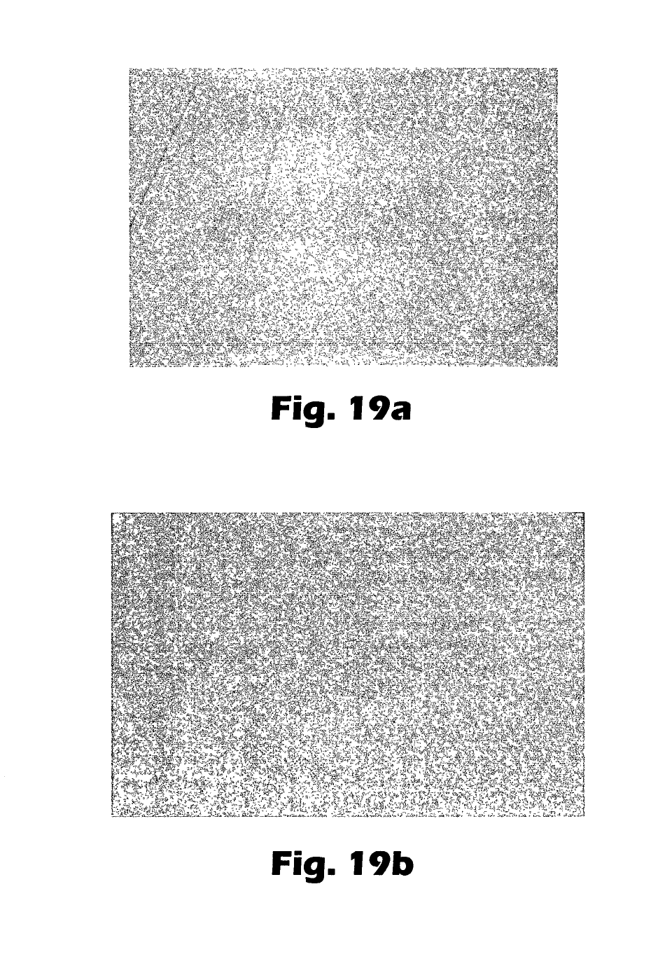

The dirty optical discs were prepared by dust deposition or fingerprints. The prepared dirty discs were cleaned with conventional disc wipe cleaning products (Control Samples 1 and 2) and the adhesive coated sheet. The discs were observed under a microscope before cleaning (as shown in FIG. 18A and 18B). Thus, although wiping can remove dust particles or fingerprints, it can cause scratches on the disc surfaces. Use of an adhesive-coated sheet removes dust particles and fingerprints without causing any scratches on disc surface. A MaxelITM CD-ROM Cleaning Cloth, Model CD-305, manufactured by Hatachi Maxell, Ltd., Osaka, Japan, was used to clean the dirty disc shown in FIG. 18A. This resulted in the scratching of the disc as illustrated in FIG. 19A. In comparison, the dirty disc shown in FIG. 18B was cleaned using the inventive repositionable adhesive coated sheet, resulting in the cleaning of the disc without causing scratching, as illustrated in FIG. 19B.

### EXAMPLE 4

The adhesive coated sheets were prepared following the procedure described in conjunction with example 3. The die-cut sheet with the configuration shown in FIG. 1 was applied to the reading side of an optical disc as was shown and described with respect to FIG. 6. The disc protected by such adhesive sheets may be kept in any secondary storage article, such as case, box, rack, spindle, or just simply and conveniently kept in a drawer, on a desk, on a shelf. The tab on the sheet may be used as an index tab to keep discs organized and easy to find.

When the disc is to be played, the protection sheet is removed from disc surface (thus the disc is cleaned) and the clean disc then may be placed into a disc player.

### EXAMPLE 5

The adhesive coated sheets were prepared following the procedure described in conjunction with example 3 except thick cardboard (20 mil) was used. The coated cardboards were then cut into rectangle shape. A stack of the coated cardboards was further fabricated into rotary, stationery or album type card system (as shown in FIG.'S 12, 16, and 17). Discs were stored into the system by adhering them adhere to the repositionable adhesive surface against the reading side of the disc. Because of the selective adhesion offered by such repositionable, the adhesive does not adhere to the paper side of the other sheet next to it. Such system, (for example, a rotary card file), provides simple, readily, effective and inexpensive means to display, retain, and select a disc.

### EXAMPLE 6-8

The adhesive coated sheets were prepared following the procedure described in conjunction with example 3 except a silicone release liner was used. The adhesive was further laminated to an optical clear transfer tape that also had a silicone release liner on the other side. Thus, the formed tape had repositionable non-tacky adhesive on one side and a tacky PSA on the other side. Both sides were covered with silicone release liners. The tape was die-cut.

The die cut tapes were used to make following examples:

Example 6— Keep a disc in book: Remove release liner on the tacky adhesive side, adhere tacky adhesive surface to a page in a book, remove the release liner on the non-tacky adhesive side, expose non-tacky adhesive surface, and attach a optical disc to the non-tacky adhesive (as shown in FIG. 13).

Example 7— Keep a disc in a three-page-folder: Remove release liner on the tacky adhesive side, adhere tacky adhesive surface to a middle side of the folder, remove the release liner on the non-tacky adhesive side, expose non-tacky adhesive surface, and attach a optical disc to the non-tacky adhesive (as shown in FIG. 14).

Example 8— Keep a minidisc on letter paper: Remove release liner on the tacky adhesive side, adhere tacky adhesive surface to the bottom comner of a letter paper, remove the release liner on the non-tacky adhesive side, expose non-tacky adhesive surface, and attach a optical disc to the non-tacky adhesive (as shown in FIG. 15).

### EXAMPLE 9-31

Adhesive sheets were prepared following the procedure described in conjunction with Example 3 except various Kraton thermoplastic block copolymer elastomers were coated on 50 cm thick polyethylene terephthalate film (Hostaphan, commercially available from Mitsubishi Polyester, Greer, S.C.). The dry coating thickness of the adhesives was controlled at 50 μm. The peel adhesion was measured on an I-MASS peel tester with 180 peel angle at 90 ipm stripping speed and followed by an ASTM method (ASTM-D3330/3330M, Test Method A, Volume15.09, Summary 1.1.1). The samples were dwelled on the substrates for 10 minutes before they were peeled.

All the Kraton thermoplastic block copolymer elastomers used in this invention have shown non-pressure sensitive adhesive properties, having relatively high adhesion to optical discs but relatively low adhesion to paper as shown in Table 2.

TABLE 2

| | Thermoplastic Adhesive | | | Peel Adhesion | |
|---|---|---|---|---|---|
| Example | Tradename | Type | % Styrene | Substrate | Peel (g/in) |
| 9 | Kraton D1107P | SIS | 15 | Disc | 1073 |
| 9.1 | Kraton D1107P | SIS | 15 | Paper | 12 |
| 10 | Kraton D1111 | SIS | 22 | Disc | 1644 |
| 11 | Kraton D1111 | SIS | 22 | Paper | 13 |
| 12 | Kraton D1193 | SIS | 24 | Disc | 1137 |
| 13 | Kraton D1193 | SIS | 24 | Paper | 3 |
| 14 | Kraton G1780 | SEPS | 7 | Disc | 35 |
| 15 | Kraton G1780 | SEPS | 7 | Paper | 0 |
| 16 | Kraton G1652 | SEBS | 30 | Disc | 219 |
| 17 | Kraton G1652 | SEBS | 30 | Paper | 0 |
| 18 | Kraton G1657 | SEBS | 13 | Disc | 154 |
| 19 | Kraton G1657 | SEBS | 13 | Paper | 0 |
| 20 | Kraton G1650 | SEBS | 30 | Disc | 360 |
| 21 | Kraton G1650 | SEBS | 30 | Paper | 0 |
| 22 | Kraton G1726 | SEBS | 30 | Disc | 10 |
| 23 | Kraton G1726 | SEBS | 30 | Paper | 0 |
| 24 | Kraton 1101 | SBS | 31 | Disc | 858 |
| 25 | Kraton 1101 | SBS | 31 | Paper | 0 |
| 26 | Kraton 1118 | SBS | 31 | Disc | 892 |
| 27 | Kraton 1118 | SBS | 31 | Paper | 0 |
| 28 | Kraton 1122 | SBS | 39 | Disc | 517 |
| 29 | Kraton 1122 | SBS | 39 | Paper | 0 |
| 30 | Kraton RP6918 | SEPS | 35 | Disc | 790 |
| 31 | Kraton RP6918 | SEPS | 35 | Paper | 12 |

### EXAMPLES 32-47

Adhesive sheets were prepared following the procedure described in adhesion with Example 3 except the dry coating thickness was varied. The peel adhesion was measured following the procedure described in example 8 to 29 except some samples were aged on discs at room temperature before they were peeled. All the data in Table 3 are peel adhesion from disc surfaces.

TABLE 3

| | | Thickness | Peel Adhesion (g/inch) | | |
|---|---|---|---|---|---|
| Example | Adhesive | (μm) | Instant | 7 Day | 14 day |
| 32 | G1652 | 12.5 | 81 | 224 | 362 |
| 33 | G1652 | 25 | 29 | 404 | 343 |
| 34 | G1652 | 58 | 36 | 208 | 502 |
| 35 | G1652 | 75 | 59 | 374 | 257 |
| 36 | G1726 | 12.5 | 4 | 2 | 14 |
| 37 | G1726 | 25 | 3 | 4 | 5 |
| 38 | G1726 | 58 | 10 | 16 | 8 |
| 39 | G1726 | 75 | 7 | 12 | 7 |
| 40 | G1650 | 12.5 | 176 | 571 | 574 |
| 41 | G1650 | 25 | 453 | 869 | 794 |
| 42 | G1650 | 58 | 374 | 1096 | 884 |
| 43 | G1650 | 75 | 333 | 1281 | 608 |
| 44 | G1657 | 12.5 | 31 | 737 | 703 |
| 45 | G1657 | 25 | 17 | 631 | 619 |
| 46 | G1657 | 58 | 8 | 291 | 269 |
| 47 | G1657 | 75 | 8 | 215 | 185 |

### EXAMPLES 48-52

Adhesive sheets were prepared following the procedure described in conjunction with Example 3 with the dry coating thickness is about 50 μm except thermoplastic block copolymer elastomers were blended. The peel adhesion was measured following the procedure described in Example 8 to 31.

TABLE 4

| | | | Peel Adhesion (g/in) | | | |
|---|---|---|---|---|---|---|
| | | | | 10 | 30 | 60 |
| Examples | Adhesive | | Initial | minutes | minutes | minutes |
| 48 | 100% | G1657 | 23 | 18 | 34 | 47 |
| 49 | 75% | G1657 | 124 | 158 | 187 | 201 |
| | 25% | D1107 | | | | |
| 50 | 50% | G1657 | 325 | 374 | 480 | 457 |
| | 50% | D1107 | | | | |
| 51 | 25% | G1657 | 396 | 665 | 1127 | 1469 |
| | 75% | D1107 | | | | |
| 52 | 100% | D1107 | 1345 | 1073 | 2570 | 2842 |

### EXAMPLES 53-68

The adhesive solutions were made with following compositions as illustrated in Table 5.

TABLE 5

| Solution | G1657 | G1652 | Wingtack 95 | Escorez 1315 | Toluene |
|---|---|---|---|---|---|
| 53 | 100 g | | 2 g | | 257 g |
| 54 | 100 g | | 5 g | | 257 g |
| 55 | 100 g | | 10 g | | 257 g |
| 56 | 100 g | | 20 g | | 257 g |
| 57 | 100 g | | | 2 g | 257 g |
| 58 | 100 g | | | 5 g | 257 g |
| 59 | 100 g | | | 10 g | 257 g |
| 60 | 100 g | | | 20 g | 257 g |
| 61 | | 50 g | 1 g | | 128 g |
| 62 | | 50 g | 2.5 g | | 128 g |
| 63 | | 50 g | 5 g | | 128 g |
| 64 | | 50 g | 10 g | | 128 g |
| 65 | | 50 g | | 1 g | 128 g |
| 66 | | 50 g | | 2.5 g | 128 g |
| 67 | | 50 g | | 5 g | 128 g |
| 68 | | 50 g | | 10 g | 128 g |

Adhesive sheets were prepared following the procedure described in conjunction with Example 3 with the dry coating thickness is about 50 μm except above compositions were coated . The peel adhesion was measured following the procedure described in Examples 8 to 31. The polycarbonate data represents peel force from an optical disc read/write surface, and the 20#/50#paper represents peel force from a non-target surface. The peel test data are shown in table 6.

TABLE 6

| | Polycarbonate (g/inch) | | | | 20#/50# Paper (g/inch) | | | |
|---|---|---|---|---|---|---|---|---|
| Solution | Initial | 10 min. | 30 min. | 60 min. | Initial | 10 min. | 30 min. | 60 min. |
| 53 | 4.4 | 4.3 | 5.3 | 6.9 | 0 | 0 | 0 | 0 |
| 54 | 5.9 | 110 | 133.2 | 140.3 | 0 | 0 | 0 | 1.6 |
| 55 | 88.4 | 148.5 | 141.7 | 126.5 | 0 | 0 | 0 | 0 |
| 56 | 94.8 | 153.6 | 98.9 | 110.4 | 0 | 0 | 0 | 0 |
| 57 | 193.4 | 196.8 | 200.1 | 241.5 | 1.8 | 3 | 2.1 | 3 |
| 58 | 174.1 | 119.6 | 163.3 | 142.6 | 0 | 2.8 | 2.2 | 2.2 |
| 59 | 174.2 | 101.2 | 133.4 | 135.7 | 0 | 0 | 0 | 0 |
| 60 | 156.3 | 105.8 | 121.9 | 142 | 0 | 1.5 | 1.7 | 1.5 |
| 61 | 48.9 | 65.4 | 73.5 | 86.1 | 15.4 | 13.2 | 11.9 | 17.6 |
| 62 | 35.8 | 36.2 | 48.3 | 45.5 | 9.1 | 8.5 | 7.7 | 8.3 |
| 63 | 24.2 | 41.7 | 52.6 | 61.2 | 2.4 | 3.5 | 3.4 | 5.5 |
| 64 | 28 | 28.4 | 40.5 | 76.9 | 0 | 1.9 | 2.5 | 3 |
| 65 | 111.9 | 133.1 | 168.2 | 146.8 | 15.8 | 24.7 | 20.5 | 24.5 |
| 66 | 43.5 | 57.4 | 70.1 | 87.2 | 7.6 | 1.9 | 11 | 15 |
| 67 | 23.4 | 38 | 53.6 | 82.2 | 1.7 | 3.9 | 2.4 | 2.7 |
| 68 | 28.3 | 34.3 | 65.1 | 77.8 | 0 | 0 | 0 | 1.7 |

In addition to and without limiting the previous discussion, the characteristics below further describe the invention. The present invention provides adhesive coated articles for optical discs comprising repositionable adhesives having a storage modulus at room temperature greater than 3×10⁵ Pascals and preferably greater than 1×10⁶.

The present invention further provides those adhesive coated articles to be used on the reading side of optical discs.

The present invention also provides novel and improved means to clean an optical disc without causing scratches comprising attaching a repositionable adhesive coated sheet to the reading side of a disc and then peeling away. The preferred adhesive will remove dirt and finger oils from the disc surface.

The present invention also provides novel and improved means to economically store an optical disc with minimum space requirements.

The present invention also provides novel and improved means to package an optical disc together with related printed (written) inforrnation providing sufficient disc protection.

The present invention also provides novel and improved means to protect an optical disc. Comparing to jewel case or sleeve, present invention completely protect the disc from being contaminated by dust and scratching.

The present invention also provides novel and improved means to index an optical disc. With a tab on protective sheet, present invention can be used to index the optical disc.

The present invention also provides novel and improved means to organize a pile of optical discs. When protective sheets are fabricated into devices, such as binders, album, rotary card files, etc. optical discs can be well organized in those devices during storage.

The present invention also provides novel and improved means to display an optical disc. The present invention could be used as a bulletin board to display discs.

The present invention further provides a novel integrated solution for disc storage, which combines disc storage with cleaning, protection, indexing, organizing, and displaying all together.

Advantageously, the repositionable adhesive is a low tack, non-pressure sensitive adhesive that allows the adhesive side of the article to be brought into contact using very light pressure with a polycarbonate surface of a disc and requires no significant force later to cleanly break the bond between the adhesive layer and polycarbonate surface of the disc.

A further embodiment of the present invention provides a sheet for applying to an optical recording media comprising a backing, a repositionable adhesive having selective adhesion on one side of backing, optionally an ink receptive coating on another side of the backing to enhance ink printing quality or writing quality, and optionally, a primer coating between the backing and the adhesive layer to enhance the adhesive bonding to the backing. Such a configuration eliminates the need for a silicone release liner.

Uniquely, because of the nature of the adhesive layer, a sheet can be cleanly removed from the optical recording medium surface and reapplied, thus assuring a cleaned, bare disc being played in a player.

Overall, this invention could be used to pack or store optical discs with enough protection from critical scratches and dusts (or debris) while taking much less space than a jewel box.

1. An article securable to an optical disc comprising:
a backing; and
a layer of repositionable adhesive disposed on the backing wherein the repositionable adhesive has a first higher adhesion level to a read/write surface on the optical disc and a second lower adhesion level to a non-target surface.

2. The article of claim 1, wherein the adhesive has a storage modulus of greater than 3×10⁵ Pascals at room temperature.

3. The article of claim 1, wherein the adhesive has a second adhesion level to non-target surface of less than about 230 grams/inch.

4. The article of claim 1, wherein the adhesive has a first adhesion level of between about 85 grams/inch to about 2550 grams/inch.

5. The article of claim 1, wherein the adhesive has a second adhesion level of less than about 28 grams/inch.

6. The article of claim 5, wherein the adhesive has a second adhesion level of less than about 15 grams/inch.

7. The article of claim 5, wherein the adhesive has a first adhesion level of between about 230 grams/inch to about 1100 grams/inch.

8. The article of claim 1 wherein the repositionable adhesive is configured so as to have a higher level of adherence to the backing than to the optical disc.

9. The article of claim 1 and further comprising:
an ink receptive layer disposed on a second side of the backing, wherein the repositionable adhesive layer is disposed on a first side of the backing.

10. The article of claim 9 and further comprising:
a liner disposed on a first side of the layer of repositionable adhesive layer.

11. The article of claim 1 and further comprising:
a secondary layer disposed between the repositionable adhesive layer and the backing.

12. The article of claim 11 wherein the secondary layer includes ink

13. The article of claim 1 and further comprising:
a layer of pressure sensitive adhesive disposed on a second side of the backing, wherein the repositionable adhesive layer is disposed on a first side of the backing.

14. The article of claim 1, wherein the backing is flexible.

15. The article of claim 1, wherein the adhesive has a storage modulus of greater than 1×10⁶ Pascals at room temperature.

16. A method for securing and removing an article from an optical disc comprising:
disposing a backing having a repositionable adhesive against a read/write surface of an optical disc, wherein the repositionable adhesive is disposed against the read/write surface; and
peeling the backing away from the optical disc, wherein the layer of repositionable adhesive has a higher level of adherence to the backing than to the optical disc.

17. The method of claim 16, wherein the repositionable adhesive has a storage modulus of greater than 3×10⁵ Pascals at room temperature.

18. The method of claim 16, wherein the repositionable adhesive has a storage modulus of greater than 1×10⁶ Pascals at room temperature.

19. The method of claim 16 further comprising:
adhering particulate from read/write surface to repositionable adhesive.

20. The method of claim 16 wherein the backing is a component in an organizational device.

21. The method of claim 16, wherein the backing is a component in a dispensing article.

22. The method of claim 16 and further comprising:
disposing an ink receptive layer on a second side of the backing; and
disposing the repositionable adhesive layer on a first side of the backing.

23. The method of claim 22 and further comprising:
disposing a liner on a first side of the layer of repositionable adhesive layer.

24. The method of claim 16 and further comprising:
disposing a secondary layer between the repositionable adhesive layer and the backing.

25. The method of claim 24 wherein the secondary layer includes ink.

26. The method of claim 16 and further comprising:
disposing a layer of pressure sensitive adhesive on a second side of the backing;
and disposing the repositionable adhesive layer on a first side of the backing.

27. The method of claim 16, wherein the backing is flexible.

28. The method of claim 16, wherein the repositionable adhesive has a first higher adhesion level to a read/write surface on the optical disc and a second lower adhesion level to a non-target surface.

29. The method of claims 28, wherein the adhesive has a second adhesion level to non-target surface of less than about 230 grams/inch.

30. The method of claim 28, wherein the adhesive has a first adhesion level of between about 85 grams/inch to about 2550 grams/inch.

31. The method of claim 29, wherein the adhesive has a second adhesion level of less than about 28 grams/inch.

32. The method of claim 31, wherein the adhesive has a second adhesion level of less than about 15 grams/inch.

33. The method of claim 30, wherein the adhesive has a first adhesion level of between about 230 grams/inch to about 1100 grams/inch.
